(19) United States
(12) Patent Application Publication
(10) Pub. No.: US 2021/0291344 A1
(43) Pub. Date: Sep. 23, 2021

(54) HAND TOOL EMBOSSED STRUCTURE AND HAND TOOL HAVING THE SAME

(71) Applicant: INFAR INDUSTRIAL CO., LTD., Chang-Hua County (TW)

(72) Inventor: Chia Hsiang CHEN, Chang-Hua County (TW)

(21) Appl. No.: 17/151,982

(22) Filed: Jan. 19, 2021

(30) Foreign Application Priority Data
Mar. 18, 2020 (TW) 109108979

(51) Int. Cl. B25G 1/10

(52) U.S. Cl. CPC B25G 1/102

(57) ABSTRACT

A hand tool embossed structure formed on a hand tool handle includes a plurality of anti-slip units embossed relative to an outer surface of the hand tool handle. Each of the plurality of anti-slip units defines a first distance along a first direction and a second distance along a second direction orthogonal to the first direction. The second distance is less than the first distance to produce a directional anti-slip characteristic.

### BACKGROUND OF THE INVENTION

The present invention relates to an embossed structure with embossed anti-slip units, and hand tool having the same.

Generally, most wrench handles on the market have a smooth outer surface via surface treatment. For example, the wrench disclosed in Taiwan Design Patent No. D186153 has a smooth handle, which is easy to cause the undesirable situation of hand-slip due to insufficient friction. In addition, if the user's hands are mixed with grease and dust, it will often lead to the disadvantage of not being able to apply force effectively.

Thus, a need exists for a novel hand tool embossed structure that mitigates and/or obviates the above drawbacks.

### BRIEF SUMMARY OF THE INVENTION

In view of the above problems, it is an object of the present invention to provide a hand tool embossed structure of which contact resistance can be increased. Moreover, it is an object of the present invention to provide a hand tool embossed structure which can provide a directional anti-slip characteristic. Further, it is another object of the present invention to provide an article having the hand tool embossed structure.

In a first aspect, a hand tool embossed structure formed on a hand tool handle includes a plurality of anti-slip units embossed relative to an outer surface of the hand tool handle. Each of the plurality of anti-slip units defines a first distance along a first direction and a second distance along a second direction orthogonal to the first direction. The second distance is less than the first distance to produce a directional anti-slip characteristic.

In an example, the first direction is the length direction of the hand tool handle, and the second direction is the width direction of the hand tool handle.

In an example, the first direction is the width direction of the hand tool handle, and the second direction is the length direction of the hand tool handle.

In an example, an outer surface of each anti-slip unit is provided with two end portions located at opposite ends of each anti-slip unit, and a middle column portion located between the two end portions along the first direction.

In an example, each of the two end portions is quarter spherical in shape, and the middle column portion is semi-cylindrical in shape.

In an example, the middle column portion is polygonal column in shape.

In an example, the plurality of anti-slip units are divided into at least one first group and at least one second group arranged along the first direction. The at least one first group and the at least one second group are parallel to each other and each include at least two anti-slip units. The at least two anti-slip units of the at least one first group and the at least two anti-slip units of the at least one second group are arranged alternately along the second direction.

In an example, the at least two anti-slip units of the at least one first group and the at least two anti-slip units of the at least one second group are arranged equidistantly from each other.

In a second aspect, a hand tool includes a hand tool handle having at least one holding surface. A driving head is arranged at a terminal portion of the hand tool handle. A plurality of anti-slip units embossed relative to the at least one holding surface of the hand tool handle. Each of the plurality of anti-slip units defines a first distance along a first direction and a second distance along a second direction orthogonal to the first direction. The second distance is less than the first distance to produce a directional anti-slip characteristic.

In an example, the hand tool further includes a marking zone formed on the at least one holding surface and surrounded by the plurality of anti-slip units.

The present invention will become clearer in light of the following detailed description of illustrative embodiments of this invention described in connection with the drawings.

### DESCRIPTION OF THE DRAWINGS

FIG. 1 is a perspective view of a hand tool with a hand tool embossed structure of a first embodiment according to the present invention.

FIG. 2 is top view of the hand tool with the hand tool embossed structure of FIG. 1.

FIG. 3 is an enlarged view of a circled portion of FIG. 2, illustrating an arrangement of a plurality of anti-slip units on a hand tool handle.

FIG. 4 is a cross sectional view of the hand tool with a hand tool embossed structure of FIG. 1.

FIG. 5 is side view of the hand tool with the hand tool embossed structure of FIG. 1, illustrating a user's hand holding a handle and the user's thumb in contact with the hand tool embossed structure.

FIG. 6 is a partial, enlarged top view of a hand tool embossed structure of a second embodiment according to the present invention.

FIG. 7 is a partial, enlarged cross sectional view of a hand tool embossed structure of a third embodiment according to the present invention.

### DETAILED DESCRIPTION OF THE INVENTION

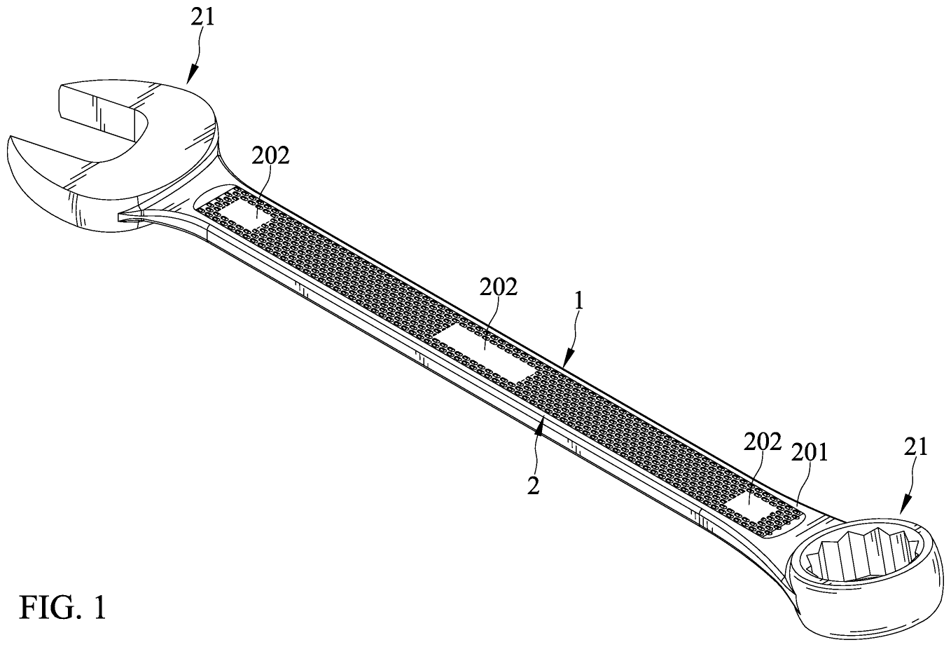

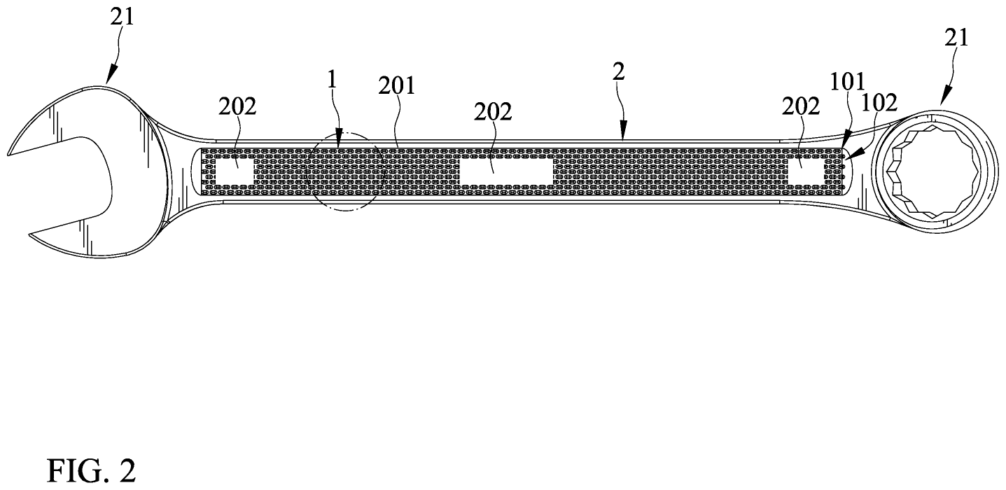

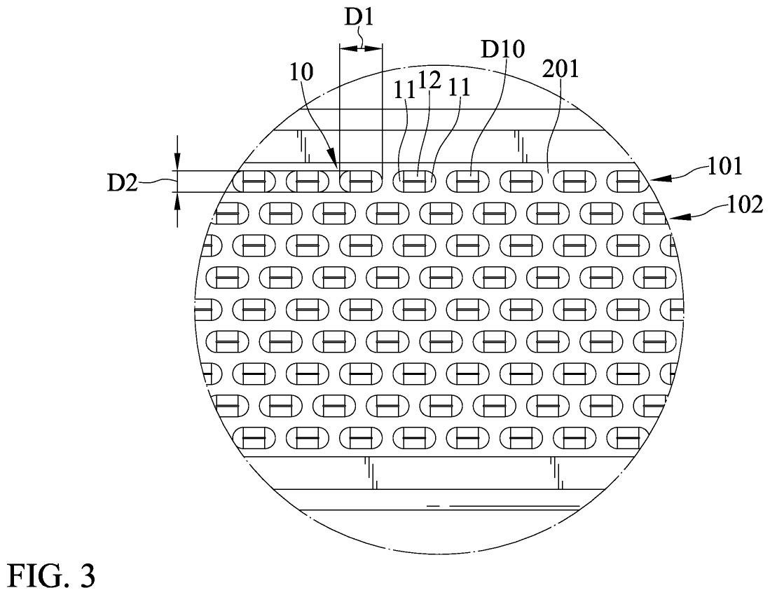

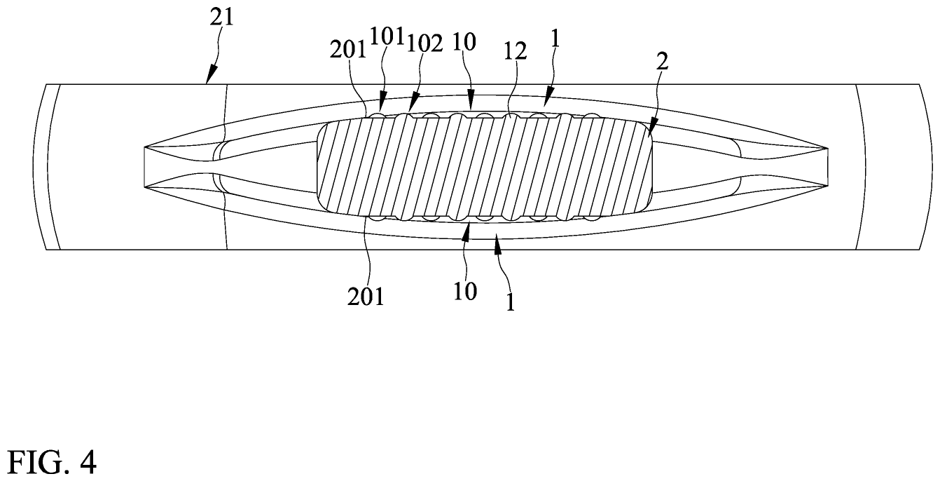

FIGS. 1-4 show a hand tool with a hand tool embossed structure 1 of a first embodiment according to the present invention. The hand tool embossed structure 1 can be formed on a hand tool handle 2 of the hand tool. It is understandable that the hand tool embossed structure 1 can be integrally formed on the hand tool handle 2 through a processing method such as stamping, and the hand tool in the embodiment may be a wrench. An outer surface of the hand tool handle 2 is formed at least one holding surface 201, and driving head 21 is arranged at a terminal portion of the hand tool handle 2. In the embodiment, two opposite of the hand tool handle 2 are both formed the holding surfaces 201, and two opposite terminal portions of the hand tool handle 2 are respectively provided with driving heads 21 of different forms. The hand tool embossed structure 1 is formed on the holding surface 201, and the hand tool further includes a marking zone 202 formed on the at least one holding surface 201 and surrounded by the hand tool embossed structure 1. The marking zone 202 can be used for embossing patterns such as trademarks and drawings. The marking zone 202 in the embodiment has three and is located at the center of the hand tool embossed structure 1 and two sides of the hand tool embossed structure 1 close to the two driving heads 21.

The hand tool embossed structure 1 includes a plurality of anti-slip units 10 embossed relative to the at least one holding surface 201 of the hand tool handle 2. Each of the plurality of anti-slip units 10 defines a first distance D1 along a first direction and a second distance D2 along a second direction orthogonal to the first direction. Further, the second distance D2 is less than the first distance D1 to produce a directional anti-slip characteristic. In the embodiment, the first direction may be the length direction of the hand tool handle 2, and the second direction may be the width direction of the hand tool handle 2.

Further, an outer surface of each anti-slip unit 10 is provided with two end portions 11 located at opposite ends of each anti-slip unit 10 and a middle column portion 12 located between the two end portions 11 along the first direction. An top edge of the middle column portion 12 is formed an anti-slip portion D10 extended between the two end portions 11 and adapted to contact the user's thumb. In the embodiment, each of the two end portions 11 may be quarter spherical in shape, and the middle column portion 12 may be semi-cylindrical in shape.

Furthermore, the plurality of anti-slip units 10 are divided into at least one first group 101 and at least one second group 102 arranged along the first direction. The at least one first group 101 and the at least one second group 102 are parallel to each other and each include at least two anti-slip units 10. The at least two anti-slip units 10 of the at least one first group 101 and the at least two anti-slip units 10 of the at least one second group 102 are arranged alternately along the second direction. In the embodiment, the at least two anti-slip units 10 of the at least one first group 101 and the at least two anti-slip units 10 of the at least one second group 102 are arranged equidistantly from each other.

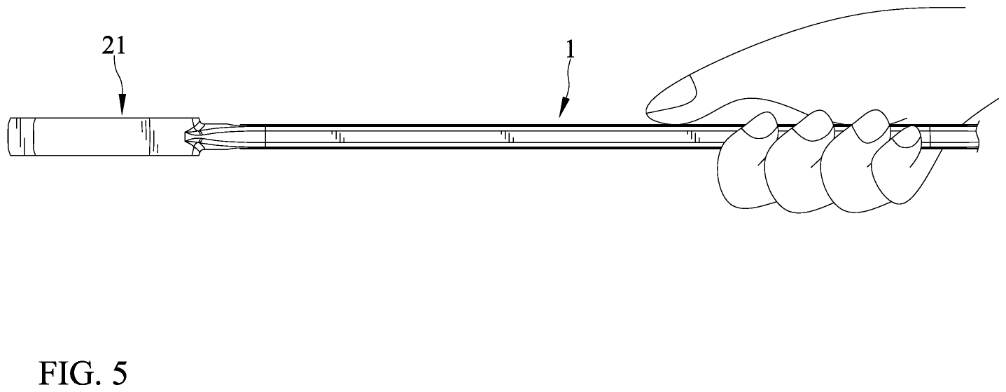

With reference to FIG. 5, when the user holds the hand tool handle 2, user's thumb can be pressed against the hand tool embossed structure 1 on the holding surface 201. The plurality of anti-slip units 10 is embossed relative to the outer surface of the hand tool handle 2, the second distance D2 is less than the first distance D1, and the quarter spherical end portions 11 and the semi-cylindrical middle column portion 12 of each anti-slip unit 10. In this way, through the special appearance design of the anti-slip unit 10, the anti-slip characteristic with the first direction in the embodiment is obtained, especially the anti-slip effect along the first direction between the holding surface 201 and user's thumb effectively prevents the undesirable situation of hand-slip due to insufficient friction, and provides the user with a hand tool that is easy to apply force.

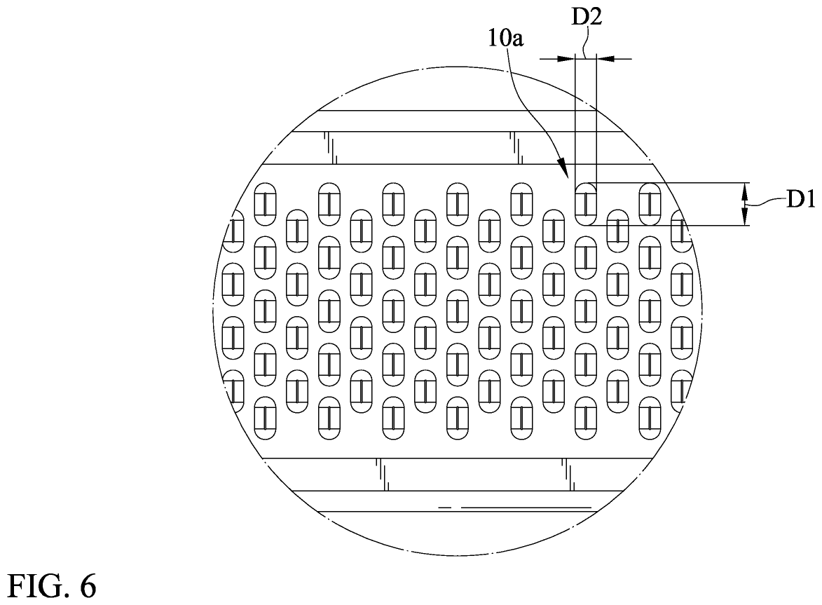

FIG. 6 is a partial, enlarged top view of a hand tool embossed structure of a second embodiment according to the present invention. The second embodiment is substantially the same as the first embodiment but is mainly different from the second embodiment by that the first direction of the anti-slip units 10a may be the width direction of the hand tool handle 2, and the second direction of the anti-slip units 10a may be the length direction of the hand tool handle 2.

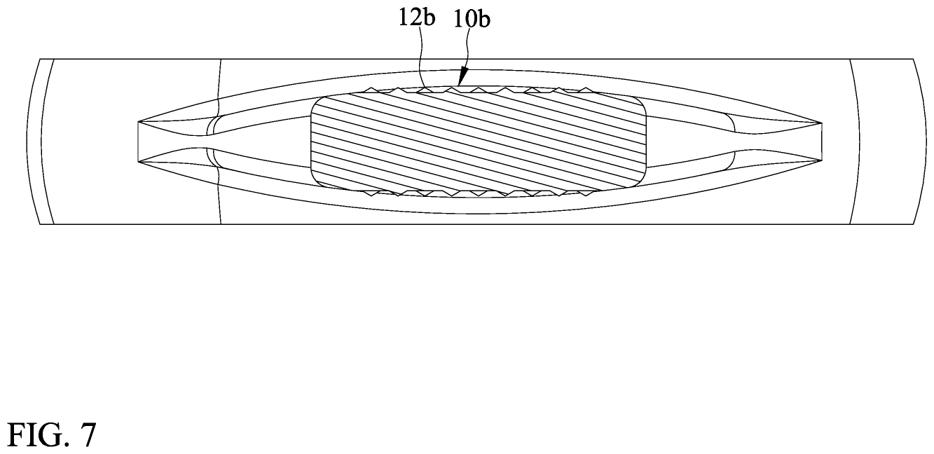

FIG. 7 is a partial, enlarged cross sectional view of a hand tool embossed structure of a third embodiment according to the present invention. The third embodiment is substantially the same as the first embodiment but is mainly different from the third embodiment by that the middle column portion 12b of each anti-slip unit 10b is polygonal column in shape, such as triangular column.

Although specific embodiments have been illustrated and described, numerous modifications and variations are still possible without departing from the scope of the invention. The scope of the invention is limited by the accompanying claims.

1. A hand tool embossed structure formed on a hand tool handle, comprising: a plurality of anti-slip units embossed relative to an outer surface of the hand tool handle, wherein each of the plurality of anti-slip units defines a first distance along a first direction and a second distance along a second direction orthogonal to the first direction, and wherein the second distance is less than the first distance to produce a directional anti-slip characteristic.

2. The hand tool embossed structure as claimed in claim 1, wherein the first direction is the length direction of the hand tool handle, and wherein the second direction is the width direction of the hand tool handle.

3. The hand tool embossed structure as claimed in claim 1, wherein the first direction is the width direction of the hand tool handle, and wherein the second direction is the length direction of the hand tool handle.

4. The hand tool embossed structure as claimed in claim 2, wherein an outer surface of each anti-slip unit is provided with two end portions located at opposite ends of each anti-slip unit, and a middle column portion located between the two end portions along the first direction.

5. The hand tool embossed structure as claimed in claim 4, wherein each of the two end portions is quarter spherical in shape, and wherein the middle column portion is semi-cylindrical in shape.

6. The hand tool embossed structure as claimed in claim 4, wherein the middle column portion is polygonal column in shape.

7. The hand tool embossed structure as claimed in claim 4, wherein the plurality of anti-slip units are divided into at least one first group and at least one second group arranged along the first direction, wherein the at least one first group and the at least one second group are parallel to each other and each include at least two anti-slip units, and wherein the at least two anti-slip units of the at least one first group and the at least two anti-slip units of the at least one second group are arranged alternately along the second direction.

8. The hand tool embossed structure as claimed in claim 7, wherein the at least two anti-slip units of the at least one first group and the at least two anti-slip units of the at least one second group are arranged equidistantly from each other.

9. The hand tool embossed structure as claimed in claim 3, wherein an outer surface of each anti-slip unit is provided with two end portions located at opposite ends of each anti-slip unit, and a middle column portion located between the two end portions along the first direction.

10. The hand tool embossed structure as claimed in claim 9, wherein each of the two end portions is quarter spherical in shape, and wherein the middle column portion is semi-cylindrical in shape.

11. The hand tool embossed structure as claimed in claim 9, wherein the middle column portion is polygonal column in shape.

12. The hand tool embossed structure as claimed in claim 9, wherein the plurality of anti-slip units are divided into at least one first group and at least one second group arranged along the first direction, wherein the at least one first group and the at least one second group are parallel to each other and each include at least two anti-slip units, and wherein the at least two anti-slip units of the at least one first group and the at least two anti-slip units of the at least one second group are arranged alternately along the second direction.

13. The hand tool embossed structure as claimed in claim 12, wherein the at least two anti-slip units of the at least one first group and the at least two anti-slip units of the at least one second group are arranged equidistantly from each other.

14. A hand tool comprising:
a hand tool handle having at least one holding surface, and wherein a driving head is arranged at a terminal portion of the hand tool handle; and
a plurality of anti-slip units embossed relative to the at least one holding surface of the hand tool handle, wherein each of the plurality of anti-slip units defines a first distance along a first direction and a second distance along a second direction orthogonal to the first direction, and wherein the second distance is less than the first distance to produce a directional anti-slip characteristic.

15. The hand tool as claimed in claim 14, further comprising:
a marking zone formed on the at least one holding surface and surrounded by the plurality of anti-slip units.
